(19) United States
(12) Patent Application Publication
(10) Pub. No.: US 2018/0298599 A1
(43) Pub. Date: Oct. 18, 2018

(54) SANITARY DEVICE FOR PLACEMENT OF DRINKS

(71) Applicant: Bryant Storey, St. Louis, MO (US)

(72) Inventor: Bryant Storey, St. Louis, MO (US)

(21) Appl. No.: 15/954,269

(22) Filed: Apr. 16, 2018

Related U.S. Application Data
(60) Provisional application No. 62/485,737, filed on Apr. 14, 2017.

(51) Int. Cl. E03D 13/00; A47G 23/02; F16M 13/02

(52) U.S. Cl. CPC E03D 13/005; F16M 13/02; A47G 23/0225

(57) ABSTRACT

A urinal Set-N-Go holder attachment for enhanced sanitary and secure placement of drinks and other hand-held sized objects includes at least one holder unit, attachment means to attach the at least one holder unit to the urinal, and connection means to connect the at least one holder attachment to the urinal attachment means. Methods of using the Set-N-Go holder attachment are also included.

### CROSS REFERENCES TO RELATED APPLICATIONS

This application claims the benefit of U.S. Provisional Application No. 62/485,737, filed on Apr. 14, 2017. The above application is incorporated herein by reference in its entirety.

### STATEMENT REGARDING FEDERALLY SPONSORED RESEARCH OR DEVELOPMENT:

Not applicable.

### BACKGROUND OF THE INVENTION

The subject matter described herein relates generally to sanitary devices for placement of drinks, mobile phones and other objects commonly brought by patrons into a public restroom to safeguard them and conveniently hold them while utilizing public and other urinals, especially in high use locations such as restaurants, sporting venues, casinos, ballrooms and airports. More generally, it relates to apparatuses and their use which add convenience and ameliorate potentially unsanitary conditions in such places.

Public urinals provide for rapid disposal of urine by men at sporting venues, restaurants and other public or other often busy gathering spots. However, frequently, those patrons using such restroom urinals or toilets may be carrying a can or bottled drink such as a beer, soda or cup of coffee or hot cocoa. They may also be in need of immediate or rapid access to their cell phones or other objects. Such objects may need to be set down while patrons use the urinals; e.g., they may not fit within their pockets, their clothes may not have pockets, or such placement, while possible, may not be either convenient or readily accomplished. Moreover, if patrons attempt to place drinks and other objects on or near the urinals, they frequently are spilled or rub up against or otherwise come into contact with unsanitary locations upon or near the urinals.

Moreover, there can be a health risk associated with such unwanted contact. Standing urine can be the repository for a variety of unhealthy conditions and disease, including among them the bacterial progenitors of diphtheria and hepatitis (Coryneform), bronchial pneumonia (Streptoccoccaceae), urinary tract infections (Pseudomonadaceae), and various kidney infections (Enterobacteriaceae), not to mention the common cold, E. coli, and hepatitis A.

While the need has long been in existence, the presence of a strategically formed, easily attached, detached and cleaned sanitary and convenient device for placement of drinks and other objects while using a urinal has long escaped us. Accordingly, such an inexpensive, yet highly salutary device has simply not been available.

### SUMMARY OF THE INVENTION

Accordingly, applicant has discovered that there is a need to address the issue of enhanced sanitary and secure placement of drinks and other objects and devices while using a public or other urinal or toilet and has devised a Set-N-Go urinal or toilet attachment to address these concerns.

In one aspect of the invention, a urinal holder attachment for use with a urinal is provided. The holder attachment includes at least one holder unit adapted to stably hold a generally hand-held object such as a can, cup or cell phone an increased distance from or position in relation to the urinal, to provide for greater sanitation. The holder attachment further includes attachment means such as a latch and mated latch holder. Additionally, the holder attachment includes means for connecting the at least one holder unit to the means for attachment to the urinal

In another aspect, a method is provided for enhanced sanitary and secure placement of an object of a generally hand-held size when using a urinal. The method includes securing the holder attachment described above to a component of a urinal which placement is an increased distance from or position in relation to the body of the urinal to provide for greater sanitation. Moreover, the hold unit is adapted to the standard configurations of cups, cans, bottles, cell phones that are commonly held to increase their secure placement. After attachment of the holder attachment, the method is completed by placing the object of a hand-held size in a secure holder unit of the holder attachment.

### BRIEF DESCRIPTION OF THE DRAWINGS

The presently disclosed subject matter will be better understood from reviewing the attached drawings, wherein below:

FIG. 1 is a front perspective view of the Set-N-Go holder attachment in accordance with the invention showing an exemplary embodiment of the holder attachment of the invention.

FIG. 2 is a collection of depictions providing various perspectives of the holder attachment of FIG. 1 and its component parts. FIG. 2a is a top plan view of the attachment holder. FIG. 2b is a front perspective view of the holder attachment of FIG. 1, but with the attachment latch removed. FIG. 2c is a rear side view of the holder attachment of FIG. 1 and FIG. 2d is a side view thereof.

FIG. 3 provides a front view (FIG. 3a) and side view (FIG. 3b) of the latch unit for the holder attachment.

FIG. 4 is a holder attachment prototype showing an embodiment of the holder attachment depicted in FIG. 1. In this photograph, the holder attachment is positioned as it might be located in use when a patron places a beer can, coffee cup, cell phone or other hand-held item in one of the two holder units depicted.

### DETAILED DESCRIPTION OF THE INVENTION

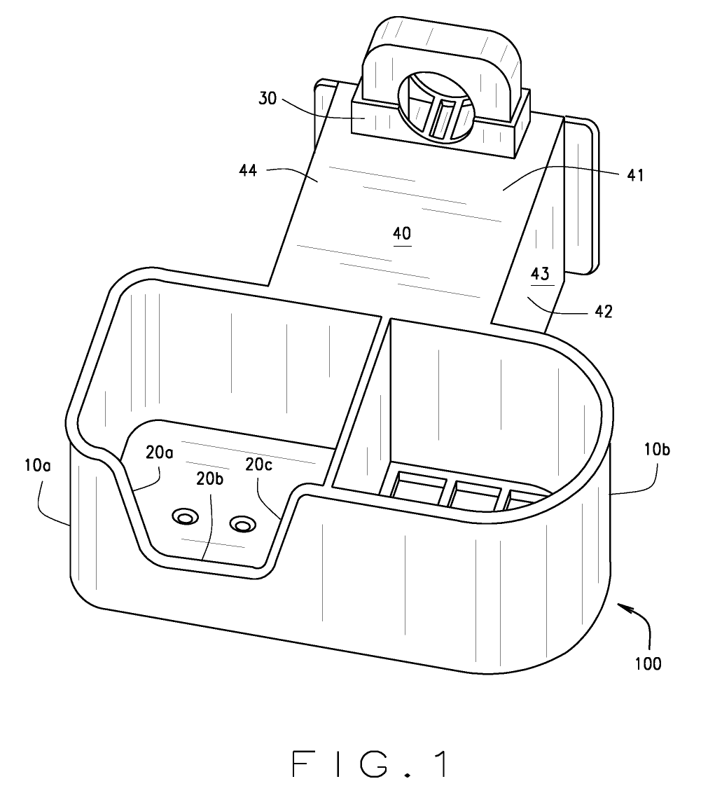

Thus, a sanitary urinal or toilet attachment for the placement of drinks and other hand-held objects while utilizing a restroom is provided which includes at least one, preferably two, and optionally more, holder units for placement of smaller, typically hand-held objects such as a can of beer, a cup of coffee or a cell phone or other hand-held smart computer unit. The attachment's holder units in preferred embodiments have open tops, sides for supporting the objects in an upright or largely upright position, and bottoms for setting down the cans and other objects in the sanitary attachment units. In preferred embodiments, the bottoms will have sufficient structure to securely hold the can, cup or a smaller object such as a phone, but will have open slots, cross-hatches or holes through which liquid which might be spilled will drain out of the bottoms. Preferably, the Set-N-Go attachment will have two or more different types of holders next to each other. For instance, on the right may be a holder with slots configured to conveniently and securely holds a can of beer or soda, while on the left is a holder unit with features configured more for a coffee cup which may have a handle (see FIG. 1, first unit with a cut out space in the front wall, which makes room for the cup's handle, e.g.). Another feature of one of the cup holders, as depicted in FIG. 1, first unit, may be a largely solid bottom surface, on which, e.g., a cell phone could more readily and securely be placed without risk of clattering to the floor. Another holder option for a cell phone or other largely flat hand-held smart computer unit could be a narrower, largely slot-like unit to more securely hold the cell phone in its common configuration.

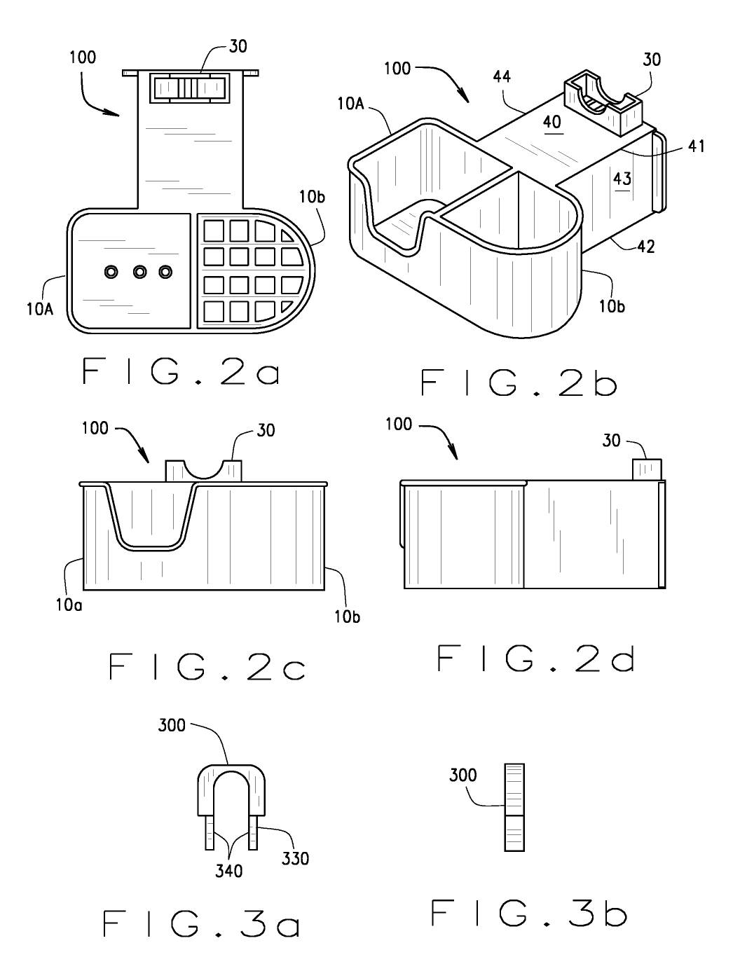

The holder units are attached to a portion or component of the urinal or other convenient nearby point of attachment with a means of attachment such as with a clip or latch which can fit down into the Set-N-Go's latch holder. See FIG. 2 for a depiction of a latch with ratchets which can be pushed down into the latch holder and thus easily tightened and secured. When the Set-N-Go is ready to be removed, e.g., to be cleaned or stored, the two ends of the latch can, e.g., in certain configurations, be reached from the underside of the Set-N-Go and squeezed together so that the ratchets on the ends freely pass over the mated portions of the latch holder section on the body of the Set-N-Go. In another embodiment, the latch is configured so that with sufficient force on the latch portion it can simply be grasped from the top and pulled up and freed from the latch holder and released. The holder attachment also includes a connection unit such as an extension portion, e.g., a rectangular block starting in back at the latch holder and extending forward a desired distance so that the one or more holder units can be readily reached by someone using the urinal but at a distance or in a position to provide for greater sanitation and secure placement when compared to placement on the urinal itself, or some unsecured placement means. This extension distance may be permanently set (see, e.g., FIGS. 1 and 3, or it may be adjustable, such as where the extension block can be pulled out to a variable amount from a base, such as from 3-10 inches, 4-8 inches, and so forth.

Methods of securely and sanitarily placing objects while utilizing a urinal (or such a holder attachment at a toilet or wash basin area of the restroom), while inhibiting unwanted contact with unsanitary surfaces using the holder attachment are also included.

As used herein, an element or step recited in the singular and preceded with the word “a” or “an” should be understood as not excluding the plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments as described and shown herein provide a Set-N-Go holder attachment to place cans, cups, cell phones and other hand-held items when utilizing a urinal (or other locales in a restroom when he/she wishes to set down the hand-held object. The holder attachment helps ameliorate the concern noted above wherein a patron using restroom facilities needs to place a hand-held object such as a can, cup, glass, cell phone, etc. at urinals, etc. which can result in loss of a drink, spillage, or rubbing up against or being set down in highly unsanitary conditions in a wide variety of venues. The holder attachment of the invention greatly aids the ability of patrons of public toilets to safely, securely, and sanitarily place their hand-held objects when there is a need to set them down.

Referring to the drawings, in one embodiment of the invention, a holder attachment 100 may be seen in FIGS. 1-2, and 4.

In the embodiment shown in FIGS. 1, 2 and 4, the holder attachment 100 includes a first 10a and a second 10b holder unit. The holder units have open tops so that the object can be readily placed into the holder unit, or they may have removable lids. The holder units have side walls configured to securely, safely and sanitarily hold a hand-held object, such as a can or cell phone when it needs to be, or is desirably, set down. The holder units have bottoms of various possible configurations. In the depicted embodiment, the first holder unit 10a is configured to conform to a typical cup for a nice snug fit. The bottom of holder unit 10a is largely solid so that a smaller, slimmer object such as a cell phone is not at risk of falling to the floor when placed in it. In the depicted embodiment, the holder unit 10b has slots or cross-hatches which provide more open space, but which still securely hold objects when placed therein.

Optionally, one of the holder units may include a carve out on the front or other side of the holder unit (see 20a, b and c) on unit 10a so that a cup or drink with a handle (or other object that needs to jut out from the holder attachment), can readily fit.

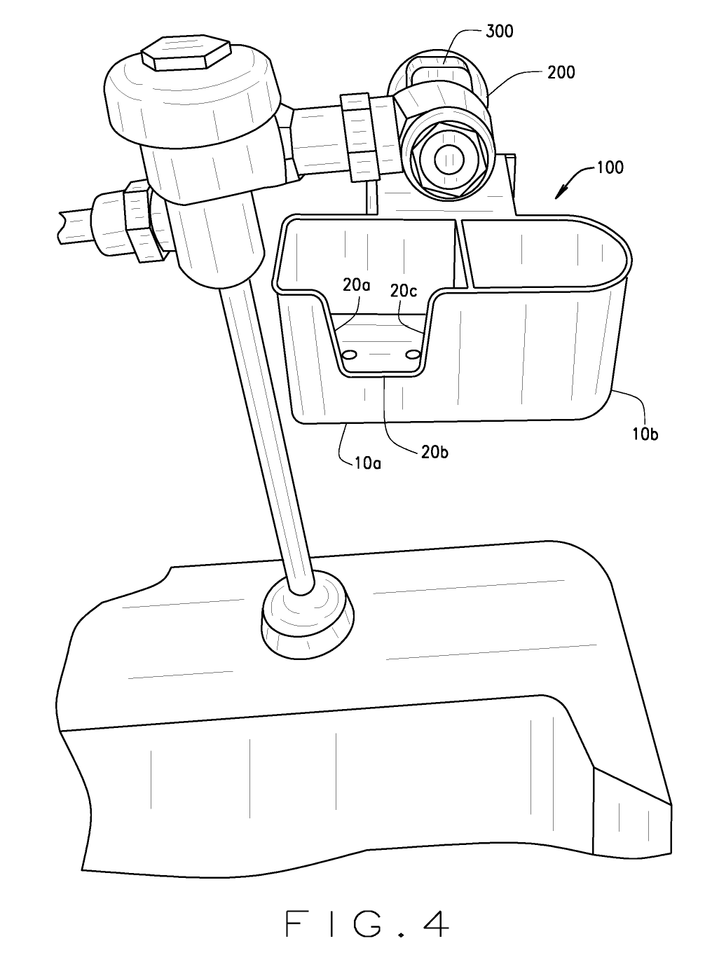

As depicted, the holder units 10a, 10b are attached to a portion or component of the urinal (see FIG. 3 200) or other convenient nearby point of attachment with a means of attachment such as with a clip or latch 300 which can fit down into or be mated with the latch holder 30. See FIG. 3 for a depiction of a latch 300 with ratchets 330 which can be pushed down into the latch holder 30 and thus easily tighten and secure the holder attachment 100 to the urinal 200. When the holder attachment 100 is ready to be removed, e.g., to be cleaned or stored, the two ends 340 of the latch 300 can, e.g., in certain configurations, be reached from the underside (such as when the underside of the latch segment has no bottom portion) and squeezed together so that the ratchets on the ends freely pass over portions of the latch holder 30 with mated ribbings in the section of the body of the Set-N-Go where the latch 300 is inserted. In another embodiment, the latch is simply configured so that with a sufficient tug on the latch 300 it can simply be grasped from the top and pulled up and freed from the latch holder 30, thus releasing the holder attachment from the urinal 200. The holder attachment 100 also includes an extension portion 40, such as a rectangular block with top 41 bottom 42 and first 43 and second sides 44 starting at the portion of the holder attachment 100 near the latch holder 30 and extending forward a desired distance so that the one or more holder units 10a, 10b can be readily reached by someone using the urinal 200. This extension distance may be permanently set (see, e.g., FIGS. 1 and 4, or it may be adjustable, such as where the extension block can be pulled on a variable amount from a base unit, such as from 3-10 inches, 4-8 inches, 5-7 inches, and so forth.

Methods of securely and sanitarily placing objects while utilizing a urinal (or a comparable holder at a toilet or wash basin area of the restroom), while inhibiting unwanted contact with unsanitary surfaces using the holder attachment are also included. The method involves providing a Set-N-Go holder attachment having the features as outlined herein for use with public or other urinals, toilets and wash basins in restrooms. Patrons use the holder attachments to place their hand-held objects as described herein in such settings and during such occasions as desired.

The Set-N-Go holder attachments may be fabricated of one or more of various sturdy, preferably somewhat flexible materials that are generally impermeable to pathogens and to noxious chemicals of the type encountered at a public restroom or urinal. These may include, but are not limited to, plastics. In some embodiments, the parts of the holder attachment may be made using an injection molded process, and the holder portion may be of one piece construction with no detachable components (as may also be the case for the latch 300). Methods of construction by injection molding and otherwise are generally known to those skilled in the art. Various embodiments may be cleaned with industrial detergents and/or hot water and soap, alcohol or other disinfectant as needed, and reused over any appropriate and/or desirable time frame.

Among the characteristics which materials used for the Set-N-Go of the invention may advantageously possess, include castability, superior physical properties such as sturdiness, but ideally with some degree of flexibility, and impermeability to pathogens such as anti-biotic resistant germs, bacteria (as mentioned above), viruses, fungi and prions. Suitable materials for use in the holder attachment may include one of, or combinations of, plastics such as polypropylene or low-density polyethylene, silicone and fluorosilicone rubbers, such as Silastic, propylenes and tetra-fluoroethylenes, polyurethane rubbers such as Adiprene, Estane and Genthane, polysulphide rubbers such as Thiokol, chloroprene rubbers and nitrile rubbers. Other materials known to those skilled in the art may be substituted in place of the above, provided they meet the requirements for durability, performance and resistance as described herein.

The holder attachments of the invention may optionally be impregnated or otherwise treated with one or more anti-pathogenic agents to enhance their protective properties and to assist in removal of germs and/or other pathogens on urinals, toilets, and other surfaces. In this embodiment of the holder attachment of the invention, the anti-bacterial agents may provide additional protection by killing pathogens at any contact points (or that would become airborne) thus further inhibiting the spread of pathogens to any unprotected patrons during their next visit to the bathroom.

While it is understood that most patrons will readily appreciate the purpose and use of the urinal holder attachment merely by its placement and configuration and will use it according to the method of the invention to enhance sanitary and secure placement of their hand-held objects, this purpose can be further enhanced by placement of signage or posters at appropriate locations near the urinals with the Set 'N Go holder attachments.

It is to be understood that the above description is intended to be illustrative, and not restrictive. For example, the above-described embodiments and/or aspects thereof may be used in combination with each other. In addition, many modifications may be made to adapt a particular situation or material to the teachings of the various embodiments of the invention without departing from their scope. While any dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the following claims, any terms such as “first,” or “second,” “left” or “right” etc. are used merely as labels, and are not intended to impose numerical or strict dimensional requirements or limitations on their objects unless so required by functional needs.

This written description uses drawings and examples of components to disclose the various embodiments of the invention, including the best mode, and also to enable any person skilled in the art to practice the various embodiments of the invention, including making and using any devices or systems and performing incorporated methods. The patentable scope of the various embodiments of the invention may include other examples that occur to those skilled in the art based on the principles explained herein. Such other examples are intended to be within the scope of the claims and description if the examples have structural elements that do not differ from the literal language of the claims and above description, or if the examples include equivalent structural elements with insubstantial differences from the literal languages of the claims.

What is claimed is:

1. A urinal holder attachment for use with a urinal comprising:
At least one holder unit adapted to stably hold a generally hand-held object such as a can, cup or cell phone an increased distance from or in position in relation to the urinal to provide for greater sanitation compared to placement on the urinal, means for attachment of the at least one holder unit to a component of the urinal, and means for connection of the at least one holder unit to the means for attachment to the urinal.

2. The urinal holder attachment of claim 1 wherein the at least one holder unit comprises at least two holder units, and one is specially adapted to hold cups with handles.

3. The urinal holder attachment of claim 1 wherein the at least one holder unit is a slot dimensioned to securely hold a smart phone.

4. The urinal holder attachment of claim 1 wherein the means for attachment to the urinal comprises a latch and a mated latch holder.

5. The urinal holder attachment of claim 1 wherein the means for connection of the at least one holder unit to the means for attachment is a generally rectangular block.

6. The urinal holder attachment of claim 1 wherein the means for connection of the at least one holder unit to the means for attachment is an extension unit extendable a variable distance from a point of attachment of the holder attachment to the urinal.

7. The urinal holder attachment of claim 1 wherein the holder attachment further comprises a material wherein a bacterial killing agent has been incorporated.

8. A method of enhanced sanitary and secure placement of an object of a hand-held size when using a urinal comprising the steps of securing a urinal holder attachment comprising:
At least one holder unit adapted to stably hold a generally hand-held object such as a can, cup or cell phone an increased distance from or in position in relation to the urinal to provide for greater sanitation compared to placement on the urinal, means for attachment of the at least one holder unit to a component of the urinal, and means for connection of the at least one holder unit to the means for attachment to the urinal to the urinal, and placing an object of a hand-held size in the at least one holder unit of the holder attachment.

9. The method of claim 8 further comprising the step of posting a sign at or near the urinal directing users to place object of a hand-held size in the urinal holder attachments.

10. The method of claim 8 wherein the at least one holder unit comprises at least two holder units, and one is specially adapted to hold cups with handles.

11. The method of claim 8 wherein the at least one holder unit comprises at least two holder units, and one is a slot narrowly dimensioned to securely hold a smart phone.

12. The method of claim 8 wherein the means for attachment to the urinal comprises a latch and a mated latch holder.

13. The method of claim 8 wherein the means for connection of the at least one holder unit to the means for attachment is a generally rectangular block.

14. The method of claim 8 wherein the means for connection of the at least one holder unit to the means for attachment is an extension unit extendable a variable distance from a point of attachment of the holder attachment to the urinal.

15. The method of claim 8 wherein an antibiotic agent which kills disease-causing biotics has been incorporated into the material of the holder attachment.
